(19) United States
(12) Patent Application Publication
(10) Pub. No.: US 2022/0340085 A1
(43) Pub. Date: Oct. 27, 2022

(54) UNDER SEAT STORAGE BOX FOR VEHICLES

(71) Applicant: M2 Distribution Ltd., Port Coquittam (CA)

(72) Inventor: Ming Li, Coquitlam (CA)

(21) Appl. No.: 17/238,720

(22) Filed: Apr. 23, 2021

(51) Int. Cl. B60R 7/04

(52) U.S. Cl. CPC B60R 7/043

(57) ABSTRACT

An under seat storage box for positioning under the rear seat of pickup truck. The storage box includes an elongated bin having a floor and sidewalls that cooperate to define a receiving chamber for receiving and storing items therein. A divider engaged with the bin and divides the receiving chamber into multiple compartments. A mesh net is engaged with the divider, and the mesh net is captively retained with the bin by the divider when the divider is in an engaged position. The mesh net removable from the bin and the divider when he divider is in a disengaged position.

### BACKGROUND

### Field of the Invention

The present invention generally relates to storage bins used in the passenger compartment of vehicles. More specifically, the invention relates to storage boxes intended for placement under the second row seating of a vehicle.

### Description of Related Art

Storage in the passenger compartment (the cab) of a pickup truck has always been at a premium. This has led to the development of storage boxes located under the rear seat of an extended/crew cab pickup truck.

These storage boxes are used to hold a wide variety of items, such as flashlights, gloves, blankets, first aid kits, tow straps, chains, jumper cables, shovels, rifles, etc. When put into a storage box, the items will remain relatively stationary as the pickup truck is driven, as long as the storage box is relatively full. However, when less than full, as the pickup truck is driven the items have a tendency to slide around inside the storage box. To combat this, some storage boxes are divided into a variety of different sized compartments. However, such fixed compartments limit the usefulness of the storage box.

### SUMMARY

In overcoming various drawbacks and limitations of the related art, the present invention provides an under seat storage box that is versatile and flexible in securely retaining items positioned within the storage box.

In one aspect of the invention, an under seat storage box is provided for use with a rear seat of pickup truck. The storage box include a bin, a divider engaged with the bin, and a mesh net engaged with the divider. The bin includes a floor, a front sidewall, a rear sidewall, a left sidewall and a right sidewall all of which cooperate to define a receiving chamber for the items to be stored in the box. The divider engages the bin and divides the receiving chamber into multiple compartments. The divider is releasably engaged with the bin and moveable between an engaged position and a disengaged position. With the divider in the engaged position, the mesh net is irremovably coupled to the bin by the divider. When the divider is in the disengaged position, the mesh net is removable from both the bin and the divider.

In another aspect, the mesh net is irremovably secured to the divider by the bin and the divider when the divider is in the engaged position, and the mesh net is removable from the bin when the divider is in the disengaged position.

In a further aspect, the mesh net is captively retained on a portion of the divider when the divider is in the engaged position.

In an additional aspect, the mesh net is captively retained on a portion of the divider by a portion of the bin when the divider is in the engaged position.

In yet another aspect, the mesh net is captively retained on a portion of the divider by the floor of the bin when the divider is in the engaged position.

In still a further aspect, the divider includes at least one finger and the mesh net is engaged with the finger of the divider.

In an additional aspect, the finger is formed along an edge of the divider.

In still another aspect, a terminal end of the finger is immediately adjacent to a surface of the bin when the divider is in the engaged position.

In yet a further aspect, a terminal end of the finger is immediately adjacent to the floor of the bin when the divider is in the engaged position.

In an additional aspect, wherein the mesh net includes at least one loop, the loop being engaged with the finger of the divider.

In another aspect of the invention, an under seat storage box for positioning under the rear seat of pickup truck is provided having an elongated bin with a floor, a front sidewall, a rear sidewall, a left sidewall and a right sidewall cooperating to define a receiving chamber for receiving items for storage therein. A pair of dividers are removably engaged with the bin and located at spaced apart locations along the bin. The dividers extend between the front side wall and the rear sidewall and divide the receiving chamber into a plurality of compartments. The divider is also removably engaged with the bin and moveable between an engaged position secured to the bin and a disengaged position not secured to the bin. A mesh net extends between the dividers and is irremovably coupled to at least one of the dividers when the dividers is in the engaged position. The mesh net can be removed from the dividers when the divider are in the disengaged position.

In another aspect, the one divider includes an upper edge and a lower edge extending between the front and rear sidewalls of the bin, the mesh net being engaged with the one divider along the lower edge.

In a further aspect, the mesh net is captively retained in engagement with the one divider along the lower edge when the one divider is in the engaged position.

In an additional aspect, in the engaged position of the one divider a portion of the bin is located immediately adjacent to the lower edge and the mesh net is captively retained thereby in engagement with the one divider along the lower edge.

In yet another aspect, in the engaged position of the one divider the floor of the bin is located immediately adjacent to the lower edge and the mesh net is captively retained in engagement with the one divider along the lower edge.

In still a further aspect, the mesh net is irremovably coupled to the pair of dividers when the dividers are in the engaged position, and the mesh net is removable from the pair of dividers when the dividers are in the disengaged position.

In an additional aspect, each of the pair of dividers includes a lower edge extending between the front and rear sidewalls of bin, at least a portion of the lower edge being immediately adjacent to a portion of the bin, each of the dividers further including a retaining member configured to engage portions of the mesh net, the retaining members being formed along the portion of the lower edge located immediately adjacent to the portion of the bin.

In still another aspect, each of the pair of dividers includes a upper edge extending between the front and rear sidewalls of bin and further includes a retaining member configured to engage portions of the mesh net generally along the upper surface.

In yet a further aspect, the mesh net includes loops on opposing ends thereof and each of the pair of dividers includes retaining members engaged with the loops.

In an additional aspect, the mesh net is elastic.

Further objects, features and advantages of this invention will become readily apparent to persons skilled in the art after review of the following description with reference to the drawings and the claims that are appended to inform a part of this specification.

### BRIEF DESCRIPTION OF THE DRAWINGS

FIG. 1 is a perspective view of the interior of a vehicle having an under seat storage box incorporating the principles of the present invention.

FIG. 2 is similar to FIG. 1 and shows the rear seat bottom in a lifted position exposing the under seat storage box.

FIG. 3 is a partially exploded view of the under seat storage box seen in FIG. 2 showing the dividers and mesh net forming a part thereof in accordance with the principles of the present invention.

FIG. 4 illustrates the under seat storage box of FIG. 3 apart from the rear seat of the vehicle.

FIG. 5 is an enlarged view of a divider and the mesh net provided in the under seat storage box seen in FIG. 4.

FIG. 6 is similar to FIG. 5 with portions broken away and showing engagement of the mesh net with the divider.

FIG. 7 is similar to FIG. 6 and shows the opposing side of the divider and the engagement of the mesh net therewith.

### DETAILED DESCRIPTION

As used in the description that follows, directional terms such as “upper” and “lower” are used with reference to the orientation of the elements as presented in the figures. Accordingly, “upper” indicates a direction toward the top of the figure and “lower” indicates a direction toward the bottom of the figure. The terms “left,” “right,” “front” and “rear” are similarly interpreted relative to the orientation of the figure and/or the vehicle, depending on the particular context in which the terms are used.

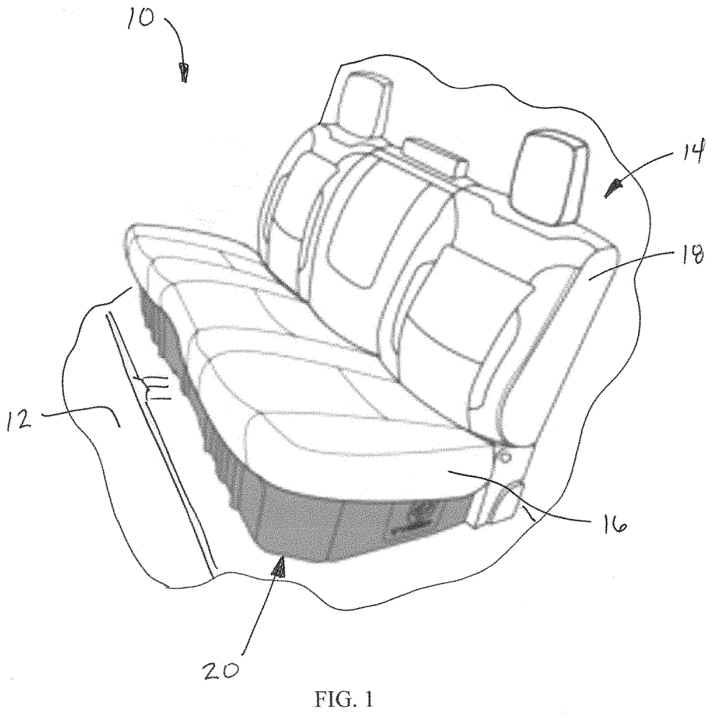

Referring now to the drawings, an under seat storage box embodying the principles of the present invention is generally illustrated in FIG. 1 and designated at 20. The storage box 20 is designed to fit within a vehicle, such as an extended/crew cab 10 of pickup truck, on its floor 12 and in a space beneath the rear seat 14. While discussed in connection with pickup trucks, it will be understood that the present storage box may be used in a wide variety of vehicles and is not intended to be limited by the discussion herein to pickup trucks.

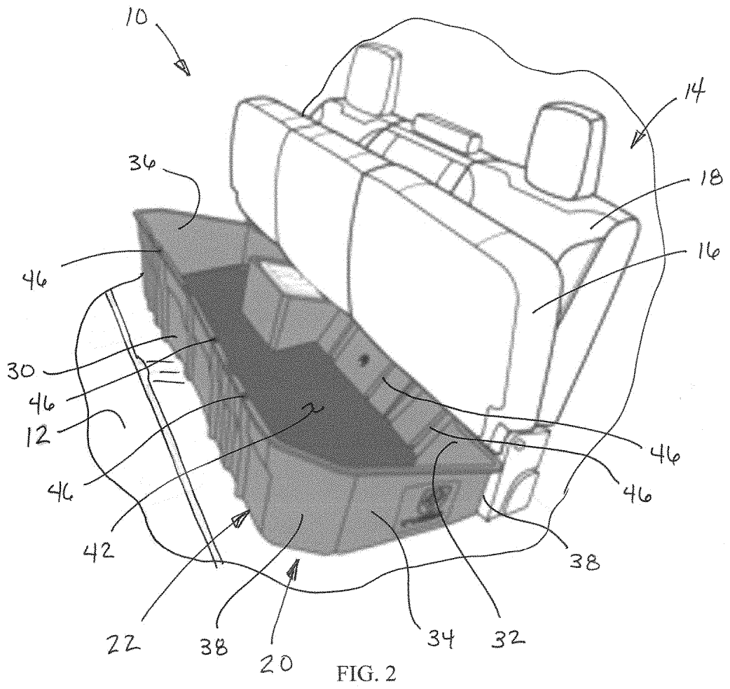

The rear seat 14 is shown with a seat bottom 16 and a stationary seat back 18. The seat bottom 16 is shown in its lowered position in FIG. 1 and is capable of being lifted or flipped-up, as seen in FIG. 2. In its lowered position, the seat bottom 16 secures the contents of the storage box 20 within the storage box 20 and conceals them from view. In its flip-up position, the seat bottom 16 permits access to the interior of the storage box 20. The storage box 20 includes as its principal components a bin 22, a plurality of dividers 24 and at least one mesh net 24.

The bin 22 is a generally rectangular open-topped box structure having a floor 28 enclosed by a plurality of substantially upright (or upwardly extending) sidewalls. The sidewalls include a front wall 30, a rear wall 32, a left end wall 34 and a right end wall 36.

The front and rear walls 30, 32 are disposed along the long sides of the bin 22 and are respectively oriented toward the front and rear of the cab 10 and the pickup truck. As will be readily appreciated by those skilled in the art, the walls 30, 32, 34, 36 need not be flat or straight walls. Rather, the walls 30, 32, 34, 36 may include embossments, recesses and projections to stiffen and strengthen the walls and/or to accommodate features of the particular model of pickup truck with which the storage box 20 is intended for use.

Between adjacent walls, the corners 38 of the bin 22 may be rounded, angled or sharp, depending on the desired aesthetics. Additionally, a lip 40 may be provided about the upper perimeter of the walls 30, 32, 34, 36 and upon which the seat bottom 16 is received when in the lowered position. Provided in this manner, a receiving chamber 42 is defined by the floor 28 and walls 30, 32, 34, 36 and can be accessed through an opening 44 defined by the lip 40 about the upper perimeter of the walls 30, 32, 34, 36.

The bin 22 may be secured within the cab 10 by various means, including without limitation, bolting it to the floor 12 or fastening it to the support frame of the rear seat 14.

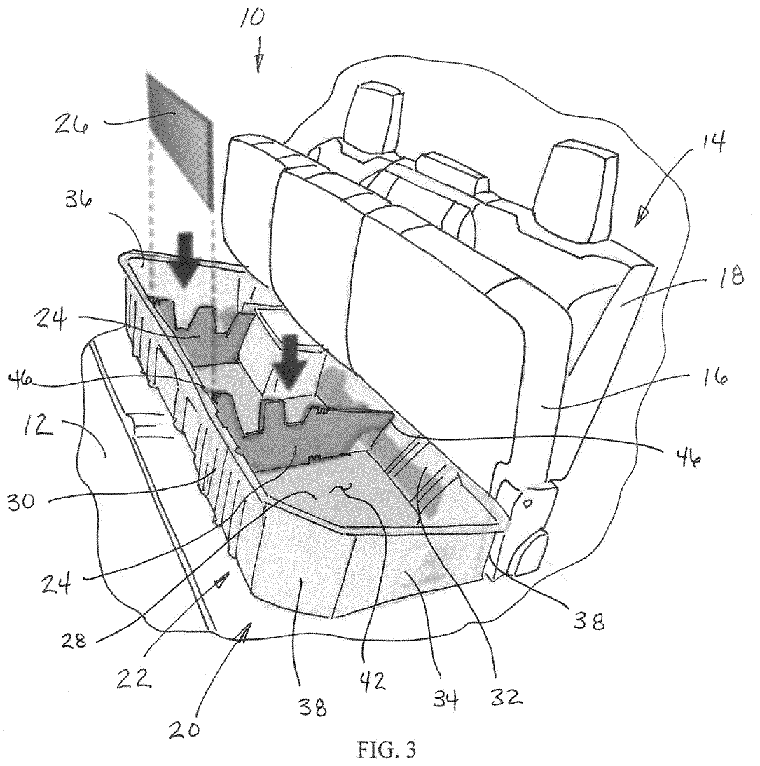

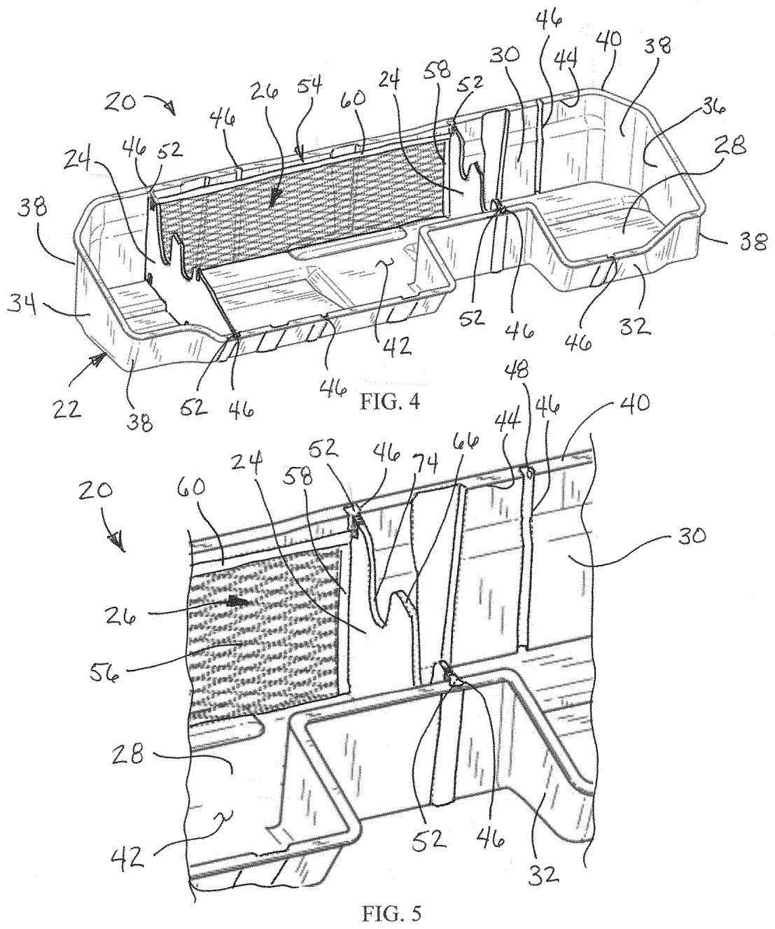

The dividers 24 are provided so as to divide the receiving chamber 42 into two or more compartments. As seen in FIGS. 3 and 4, two dividers 24 are arranged within the bin 22, extending between the front and rear walls 30, 32 so as to divide the receiving chamber 42 into three compartments. Additional dividers 24 may employed to divide the receiving chamber 42 into additional compartments.

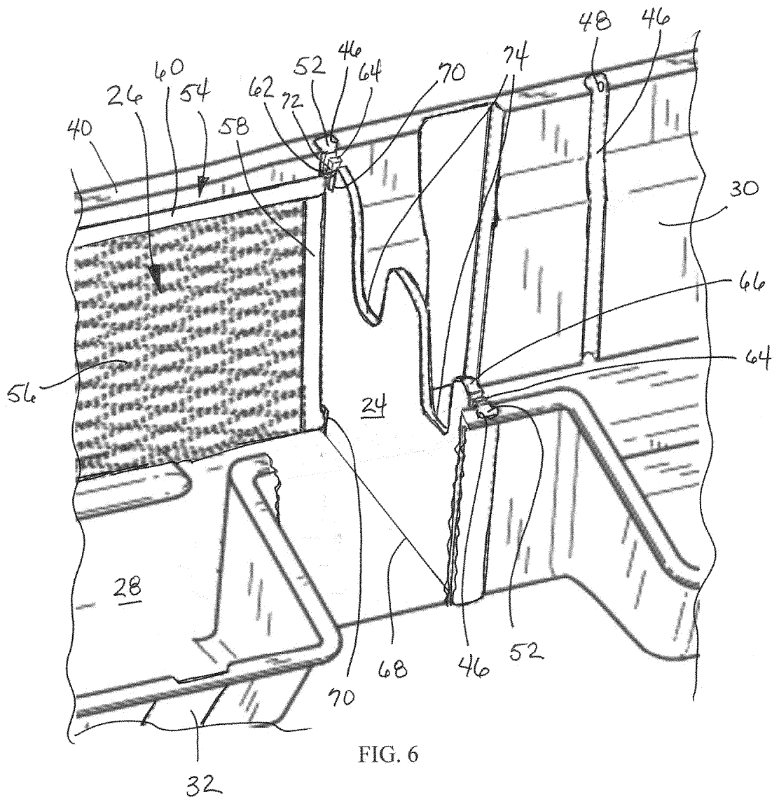

To position the dividers 24 within the bin 22, the front and rear walls 30, 32 have formed therein sets of opposed grooves 46 that extend generally upright and vertical from the floor 28 to and through the lip 40 that is located about the perimeter of the bin 22. At the upper extent of the grooves 46, the grooves 46 are provided with protrusions 48 (see FIGS. 5 and 6) that operate to secure the dividers 24, as discussed below.

The dividers 24 include tabs 50, provided along their front and rear edges, that are configured to be received within the grooves 46. Thus, the length of a given divider 24, from rear edge to front edge, corresponds with the distance between a pair of opposed grooves 46. Accordingly, some dividers 24 may be employed is certain locations of the bin 22 and not others because they are either too long or too short in the lengthwise direction.

To secure the dividers 24 within the bin 22, the tabs 50 are located in the desired grooves 46 of the bin 22 and the dividers 24 are slid downward toward the floor 28. As the divider 24 approaches the floor 28, enlarged portions or bosses 52 provided on the upper ends of the tabs 50 engage the protrusions 48. By pushing the divider 24 down further in the groove 46 toward the floor 28, the bosses 52 snap over the protrusions 48 and a divider 24 is retained in the grooves 46 and the bin 22.

The dividers 24 can be removed from bin 22 and the grooves 46 by reversing this process and pulling upward on the dividers 24 with a force sufficient to overcome the engagement of the bosses 52 and the protrusions 48. Approximately the same amount of force is required to engage and/or disengage the dividers 24 with the bin 22 in the grooves 46.

As mentioned above, the storage box 20 includes a mesh net 26. The mesh net 26 is preferably elastic and cooperates with the dividers 24 and walls 30, 32, 34, 36 to form expandable pockets 54 with an adjacent wall (such as the front wall 30) within the storage box 20. The expandable pockets 54 allow for retained placement of smaller items within the storage box 20. For example, while not shown, a series of single use water bottles (or other items) may be placed side-by-side in the pocket 54, between the mesh net 26 and the front wall 30 (see FIG. 4) allowing for easy and convenient access to the water bottles, while keeping them both clean and readily available.

The mesh net 26 preferably includes a central panel 56 of elastic nylon netting that extends between lateral ends 58. The lateral ends 58 may be formed by the nylon netting itself or may be formed as strips or bands of a reinforcing material, such as nylon webbing, that is folded over and sewn about the ends of the central panel 56. The latter is shown in the figures. The bands defining the ends 58 may also exhibit elasticity. The upper and lower sides 60 of the central panel 56 (the lengthwise or longitudinal sides of the central panel 56) may also be formed as strips or bands of a reinforcing material, again such as nylon webbing, folded over and sewn about these ends of the central panel 56. Alternatively, the central panel 58 of the mesh net 26 may be formed as a double layer panel with a closed lower end and an open upper end, thereby forming a pocket within the panel 58 itself.

While described as being a mesh net and formed of a mesh netting, the mesh net 26 may be provided in a form not using netting material. In other words, the mesh net 26 may be provided in the form of a flexible panel of fabric, preferably elastic fabric. Accordingly, the term mesh net, as used herein, includes such an item that is formed from mesh and/or netting or a non-mesh, non-netting material, such as a sheet of fabric.

Each of the four corners of the mesh net 26 are provided with a loop 62 of material, preferably elastic material, that is used to engage the mesh net 26 with the dividers 24. For this purpose, the dividers 24 include fingers 64 over which the loops 62 are positioned.

The fingers 64 are provided along the upper and lower edges 66, 68 of the dividers 24 at locations adjacent to the tabs 50. Accordingly, one finger 64 is located adjacent to the top of the tab 50 and another finger 64 is located adjacent to the bottom of the tab 50. The fingers 64 may also be located along the upper and lower edges 66, 68 at location spaced apart from the tabs 50, as seen in FIG. 4.

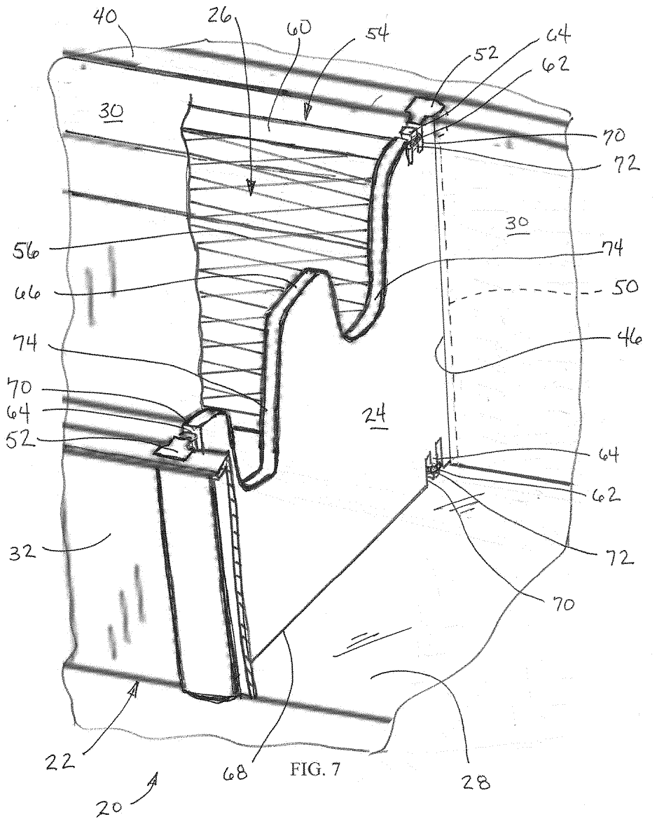

As perhaps best seen in FIG. 7, the fingers 64 are provided in cutouts or recesses 70 formed along the upper and lower edges 66, 68. The fingers 64 extend from the bottoms of these cutouts 70, away from each other and, respectively, generally toward the upper or lower edges 66, 68 of the divider and terminate with a height corresponding to the upper or lower edge 66, 68. The fingers 64 may also be provided with a circumferential recess or groove 72 about the shaft of the finger 64 and into which the loops 62 of the mesh net 26 are received.

With the above construction, the mesh net 26 is locked in position on the divider 24 and in the bin 22 when the dividers 24 are fully engaged in the grooves 46 and retained within the bin 22. This occurs as a result of the lower fingers 64, with the loops 62 positioned there around, having their terminal ends located immediately adjacent to and/or contacting a surface of the bin 22, specifically the floor 28, when the bosses 52 are engaged with the protrusions 48 locking the dividers 24 with the bin 22. As used herein, the terminal ends of the fingers 64 are immediately adjacent to a surface of the bin 22 when the gap between the terminal ends and surface of the bin 22 is small enough to prevent the loops 62 from being pulled off of the ends of fingers 64 through any gap between the terminal ends of the fingers 64 and the floor 28. The lower loops 62 are therefore captively trapped on the lower fingers 64 whenever the divider 24 is fully engaged with the bin 22, as specifically seen in FIG. 7. For this reason, the lower edges 68 of the dividers 24 preferably conform to the shape of the surface of the floor 28, notwithstanding the cutouts 70.

As noted above, the fingers 64 along the upper and lower edges 66, 68 of a divider 24 extend in directions opposed to one another. By appropriately sizing the mess net 26, the elasticity of the mesh net 26 cooperates with the orientation of the fingers 64 to retain the mesh net 26 in engagement on the dividers 24. In this regard too, the fingers 64 along the lower edge 68 need not contact the floor 28 and the terminal ends thereof may be more liberally spaced apart from the floor 28. The presence of the floor 28 or adjacent portion of the bin 22, however, still aids in retaining the mesh net 26 engaged with the dividers 24 by obstructing, interfering and limiting the amount of downward movement of any item pulling or pushing downward on the loops 62.

The upper edges 66 of the dividers 24 need not, but may, conform to the height of the perimeter defined by the lip 40. In the figures, the upper edges 66 are shown as being formed with deep recesses 74. These deep recesses 74 allow long handled items, such as shovels, to be placed in the storage box 20, with the handles in the deep recesses 74, even with the dividers in place.

As a person skilled in the art will readily appreciate, the above description is only meant as an illustration of an implementation of the principles of the present invention. Accordingly, this description is not intended to limit the scope or application of this invention since the invention is susceptible to modification, variation and change, all without departing from the spirit of the invention, as defined in the following claims.

I/We claim:

1. An under seat storage box for use with a rear seat of a vehicle, the storage box comprising:
an elongated bin having a floor, a front sidewall, a rear sidewall, a left sidewall and a right sidewall cooperating to define a receiving chamber for receiving items for storage therein;
a divider engaged with the bin and dividing the receiving chamber into a plurality of compartments, the divider being releasably engaged with the bin and moveable between an engaged position and a disengaged position; and
a mesh net engaged with the divider, the mesh net being irremovably coupled to the bin by the divider when the divider is in the engaged position, and the mesh net being removable from the bin when the divider is in the disengaged position.

2. The under seat storage box according to claim 1, wherein the mesh net is irremovably secured to the divider by the bin and the divider when the divider is in the engaged position, and the mesh net is removable from the bin when he divider is in the disengaged position.

3. The under seat storage box according to claim 1, wherein the mesh net is captively retained on a portion of the divider when the divider is in the engaged position.

4. The under seat storage box according to claim 1, wherein the mesh net is captively retained on a portion of the divider by a portion of the bin when the divider is in the engaged position.

5. The under seat storage box according to claim 1, wherein the mesh net is captively retained on a portion of the divider by the floor of the bin when the divider is in the engaged position.

6. The under seat storage box according to claim 1, wherein the divider includes at least one finger and the mesh net is engaged with the finger of the divider.

7. The under seat storage box according to claim 6, wherein the finger is formed along a lower edge of the divider and extends in a direction toward the floor of the bin.

8. The under seat storage box according to claim 7, wherein a terminal end of the finger is immediately adjacent to a surface of the bin when the divider is in the engaged position.

9. The under seat storage box according to claim 7, wherein a terminal end of the finger is immediately adjacent to the floor of the bin when the divider is in the engaged position.

10. The under seat storage box according to claim 6, wherein the mesh net includes at least one loop, the loop being engaged with the finger of the divider.

11. An under seat storage box for positioning under the rear seat of a vehicle, the storage box comprising:
an elongated bin having a floor, a front sidewall, a rear sidewall, a left sidewall and a right sidewall cooperating to define a receiving chamber for receiving items for storage therein;
a pair of dividers being removably engaged with the bin and located at spaced apart locations along the bin, the dividers extending between the front side wall and the rear sidewall and dividing the receiving chamber into a plurality of compartments, the divider being removably engaged with the bin and moveable between an engaged position secured to the bin and a disengaged position not secured to the bin; and
a mesh net extending between the dividers, the mesh net being irremovably coupled to at least one of the dividers when the one of the dividers is in the engaged position, and the mesh net being removable from the one of the dividers when the one of the dividers is in the disengaged position.

12. The under seat storage box according to claim 11, wherein the one divider includes an upper edge and a lower edge extending between the front and rear sidewalls of the bin, the mesh net being engaged with the one divider along the lower edge.

13. The under seat storage box according to claim 12, wherein the mesh net is captively retained in engagement with the one divider along the lower edge when the one divider is in the engaged position.

14. The under seat storage box according to claim 12, wherein in the engaged position of the one divider a portion of the bin is located immediately adjacent to the lower edge and the mesh net is captively retained thereby in engagement with the one divider along the lower edge.

15. The under seat storage box according to claim 12, wherein in the engaged position of the one divider the floor of the bin is located immediately adjacent to the lower edge and the mesh net is captively retained in engagement with the one divider along the lower edge.

16. The under seat storage box according to claim 11, wherein the mesh net is irremovably coupled to the pair of dividers when the dividers are in the engaged position, and the mesh net is removable from the pair of dividers when the dividers are in the disengaged position.

17. The under seat storage box according to claim 11, wherein each of the pair of dividers includes a lower edge extending between the front and rear sidewalls of bin, at least a portion of the lower edge being immediately adjacent to a portion of the bin, each of the dividers further including a retaining member configured to engage portions of the mesh net, the retaining members being formed along the portion of the lower edge located immediately adjacent to the portion of the bin.

18. The under seat storage box according to claim 11, wherein each of the pair of dividers includes a upper edge extending between the front and rear sidewalls of bin and further includes a retaining member configured to engage portions of the mesh net generally along the upper surface.

19. The under seat storage box according to claim 11, wherein the mesh net includes loops on opposing ends thereof and each of the pair of dividers includes a pair of retaining members engaged with the loops, the pair of retaining members of a divider extending in opposing directions from each other.

20. The under seat storage box according to claim 11, wherein the mesh net is elastic.
